(19) United States
(12) Patent Application Publication
(10) Pub. No.: US 2010/0146094 A1
(43) Pub. Date: Jun. 10, 2010

(54) Method And System For Compressing Files Based On Their Popularity In A Network

(75) Inventors: Ronny Elkayam, Kiryat Ono (IL); Michael Shurman, Bat Hefer (IL)

Correspondence Address: ROBERT G. LEV, 4766 MICHIGAN BLVD., YOUNGSTOWN, OH, 44505, US

(73) Assignee: Unison Play Ltd., Tel Aviv (IL)

(21) Appl. No.: 12/450,455

(22) PCT Filed: Mar. 30, 2008
(86) PCT No.: PCT/IL08/00440

§ 371 Date: Sep. 25, 2009

Related U.S. Application Data
(60) Provisional application No. 60/907,306, filed on Mar. 28, 2007.

(51) Int. Cl. G06F 15/173

(52) U.S. Cl. 709/223

(57) ABSTRACT

A method for file storage management. The method includes the steps of determining by a first computer, for a plurality of peer computers in a communication network of the first computer, information on the storage management of blocks of the file by the peer computers. In addition, the method includes selecting, by the first computer, blocks of the file to be made available to the first computer independently of the plurality of peer computers, responsive to the determined information and managing a storage unit of the first computer, such that the non-selected blocks of the file are not stored locally by the first computer.

### FIELD OF THE INVENTION

The present invention relates to data communications and particularly to storage and access of data files in peer to peer networks.

### BACKGROUND OF THE INVENTION

The Internet is used to provide users with access to many data files, including audio and video files. Most data files are provided by a server which hosts the files for provision to users. As the quantity of data stored electronically for provision over the Internet is enormous, some web sites employ a plurality of servers which store different portions of their data content.

US patent publication 2007/0078809 to Semkow et al., titled “Robust data availability system having decentralized storage and multiple access paths”, the disclosure of which is incorporated herein by reference in its entirety, describe methods of distributed storage of files.

Another popular method for data provision is peer-to-peer delivery of files. In this method, the client computers around the world serve as servers for the data stored thereon. A client computer that requests a file may receive the file from one or more peer clients connected to the Internet.

US patent publication 2007/0250880 to Hainline, titled: “Peer-to-peer video on demand techniques”, the disclosure of which is incorporated herein by reference in its entirety, describes one such peer-to-peer network.

One of the problems with peer storage is that peer clients are not necessarily available at all times and desired files are not necessarily available when required. Consequently, cautious users tend to store all files they may want in the future on their own computer systems, requiring in some cases enormous data storage facilities.

PCT patent publication WO2005/038617, titled: “Computer System and Methods for Enhancing the Distribution and Revenue Streams Derived from Works Made Available in Digital Form”, the disclosure of which is entirely incorporated herein by reference, suggests providing monetary incentives to clients that host files and provide upload bandwidth: The suggested approach may increase the number of clients providing files in peer-to-peer networks, but does not address the problem of user's requiring assurance that files of interest will be available when required.

U.S. Pat. No. 7,069,295 to Sutherland et al., titled: “Peer-to-peer enterprise Storage”, the disclosure of which is incorporated herein by reference in its entirety, describes centrally controlled storage in a peer-to-peer network.

While such central control may solve the problem of file availability assurance it introduces a new problem in that some users may be unwilling to allow external control of their storage area or portions thereof.

US patent publications 2006/0294571 to Moore et al., titled “Collaborative Video Via Distributed Storage and Blogging” and 2006/0242155 to Moore et al., titled “Systems and Methods for Providing Distributed, Decentralized Data Storage and Retrieval”, the disclosures of which are entirely incorporated herein by reference, describe a method of storing video data on a plurality of peer client computers. Participants are compensated for allowing storage on their client computers by receiving a percentage of the revenues from ads and/or by reciprocal storage services.

U.S. Pat. No. 7,020,665 to Douceur et al., titled: “File Availability in Distributed File Storage Systems”, the disclosure of which is entirely incorporated herein by reference, describes a two stage method of determining appropriate locations for placing replicas in a peer network.

US patent publication 2007/0067332 to Gallagher et al., titled: “Distributed, Secure Digital File Storage and Retrieval”, the disclosure of which is entirely incorporated herein by reference, describes a file segmenter and distributor which receive files for storage, segment them and then distribute them to storage nodes, which may be selected according to their upload bandwidth, their operation schedule and such parameters.

US patent publication 2006/0190615 to Panwar et al., titled “On Demand Peer-to-Peer Video Streaming with Multiple Description Coding”, the disclosure of which is incorporated herein by reference, describes a method in which a video file is broken into a plurality of portions which are stored in a plurality of peer storage units. This publication discusses fast delivery of files in peer-to-peer networks.

The peer nodes usually have limited storage space and if this is not taken into consideration by storage control systems, the amount of available storage will quickly run out.

### SUMMARY OF THE INVENTION

An aspect of some embodiments relates to a distributed method for managing storage of files in a peer-to-peer network. In accordance with the distributed method, clients instructed to store a file in a shared manner determine information on the storage of the file by peer clients of the network and accordingly decide which blocks of the file they should store themselves and for which blocks they will rely on peer clients. Optionally, the various clients exchange commitments to store blocks of the file with each other. In some embodiments of the invention, each client controls only its own storage and clients do not instruct peers regarding the data they are to store. Using a distributed method to control the storage makes the storage process more robust and independent of centralized control.

In some embodiments of the invention, the decision as to which blocks to store locally on a client is configured to ensure real time delivery of the file to the client at a streaming rate allowing, for example, real time display of a video file. Optionally, the client determines to store a local copy of any block of the file which does not have at least a predetermined number of peer clients storing the block and/or the clients storing the block do not have a sufficient aggregated amount of upload bandwidth. Alternatively or additionally, the determination of the portions stored locally depends on the known or estimated availability of the peer storage devices and/or the distance between the determining device and its peers, for example as represented by the round trip time of signals transmitted between them.

Alternatively or additionally, a user may set the level of redundancy required according to user preferences.

In some embodiments of the invention, each of the storage devices is assigned score points for storing file portions and/or for providing file portions to clients. The assigned score points are optionally usable in paying for downloading files from other storage devices and/or in receiving commitments to store file blocks.

An aspect of some embodiments of the present invention relates to a peer to peer network in which clients are assigned score points for providing data provision services, and the assigned score points are usable in purchasing data services within the network. In some embodiments of the invention, a separate score is assigned for each file. Alternatively, a score is assigned for a plurality of files, possibly for all the files shared by the client, together. Using a score achieves a relatively even and fair distribution of the storage of files throughout the network.

Optionally, score points are provided to clients for each block of the file that they store. Alternatively or additionally, score points are provided to clients for each commitment to store a block given to a peer client. Further alternatively or additionally, score points are provided for each block or segment the client actually uploads. In some embodiments of the invention, for each commitment to store a block for a client, the client loses one or more score points to the peer client agreeing to store the block. The blocks may all be assigned the same number of score points, regardless of their size and the parameters of the computer storing them. Alternatively, different computers are allocated different numbers of score points, for example, according to the upload bandwidth of the computer storing the block, such that a computer having a large uplink bandwidth is assigned a larger number of score points for each block it stores.

An aspect of some embodiments of the present invention relates to distributed storage of file blocks in a peer to peer network based on selection of a sub-group including fewer than all the computers in the network and making storage decisions for the file only based on information relating to the computers in the sub-group. In some embodiments of the invention, the distributed storage includes achieving agreements between computers of the network on the blocks they are to store, such that the computers in the sub-group store a sufficient number of copies of the blocks of the file, without relation to the blocks stored by computers not included in the sub-group. It will be appreciated that though relating only to a sub-group typically reduces the efficiency of the sharing, it simplifies the communications and calculations required to manage the file storage.

Optionally, the sub-group includes fewer than half the computers storing portions of the file in the network, or even fewer than 10% of the computers storing a portion of the file. In some embodiments of the invention, the sub-group includes fewer than 1000, fewer than 500 or even fewer than 300 computers.

An aspect of some embodiments of the present invention relates to controlling a rate of requesting file segments in downloading a file from a distributed storage formed from a plurality of storage devices (e.g., computers of a peer to peer network), responsive to knowledge concerning parameters of the storage devices from which the file segments are requested. Optionally, the rate control of the requests is performed responsive to the upload bandwidth of the storage devices to which the requests are transmitted.

There is therefore provided in accordance with an exemplary embodiment of the invention, a method of storage management of a file, comprising determining, by a first computer, for a plurality of peer computers in a communication network of the first computer, information on the storage management of blocks of the file by the peer computers; selecting, by the first computer, blocks of the file to be made available to the first computer independently of the plurality of peer computers, responsive to the determined information; and managing a storage unit of the first computer, such that the non-selected blocks of the file are not stored locally by the first computer.

Optionally, the method includes the first computer creating a table indicating for each block not stored in the storage unit of the first computer, from which peer computers it may be retrieved. Optionally, determining for a plurality of peer computers comprises determining for up to a maximal number of peer computers. Optionally, determining for up to a maximal number of peer computers comprises determining for up to a limit not greater than 2000. Optionally, determining for up to a maximal number of peer computers comprises determining for a number of computers selected responsive to a parameter of the file. Optionally, determining for up to a maximal number of peer computers comprises determining for a number of computers selected responsive to an importance rating or size of the file. Optionally, determining for a plurality of peer computers comprises determining for a group of peer computers selected according to the time at which they joined the sharing of the file. Optionally, determining for a plurality of peer computers comprises determining for a group of peer computers selected as up to a predetermined number of computers most recently joining the sharing of the file.

Optionally, the plurality of peer computers are selected at least partially responsive to times at which they joined the sharing of the file. Optionally, the plurality of peer computers are selected at least partially responsive to scores given to the peer computers relating to an extent of their participation in storing blocks of shared files. Optionally, selecting blocks to be made available independently of the plurality of peer computers comprises selecting blocks to be stored locally by the first computer. Optionally, selecting blocks to be made available independently of the plurality of peer computers comprises selecting blocks to be downloaded from a server. Optionally, selecting blocks of the file to be made available to the first computer independently of the plurality of peer computers comprises selecting responsive to a determination as to which blocks are stored by a low number of the plurality of peer computers.

Optionally, selecting blocks of the file comprises determining for each block which peer computers have committed to other peer computers to store the block.

Optionally, selecting blocks of the file comprises selecting blocks for which a sufficiently high confidence level that the block will be delivered in real time when requested, cannot be achieved based on the storage of the block by the plurality of peer computers.

Optionally, managing the storage unit of the first computer comprises erasing non-selected blocks from the storage unit. Optionally, the method includes requesting, for each block not selected, commitments to store the block, from one or more peer computers. Optionally, requesting, for each block not selected, commitments to store the block, from one or more peer computers comprises requesting from at least 10 computers. Optionally, the method includes verifying periodically that the computers providing commitments are available and their commitment is in force. Optionally, the method includes determining a score for the first computer, based on the number of selected blocks and the number of commitments the first computer requests. Optionally, the first computer requests commitments to store a block from a second computer that is not committed to store the block for other computers, only if the score of the first computer is greater than the score of the second computer. Optionally, the method includes determining a score for the first computer, based on the number of selected blocks.

Optionally, the method includes receiving, by the first computer, a user instruction to share the file and determining the information on the storage management of blocks of the file by the peer computers, responsive to the instruction.

Optionally, receiving the instruction to share the file comprises placement of the file in a sharing area of the storage unit. Optionally, receiving the instruction to share the file comprises receiving an instruction to display a video file not having portions stored locally by the first computer, and wherein the instruction is considered to implicitly indicate an instruction to share the file. Optionally, receiving the instruction to share the file comprises receiving an indication that a descriptor of the file was downloaded to the computer and wherein the determining of the information on the storage management of the file is performed responsive thereto without a further user instruction. Optionally, the file comprises a video file and wherein the descriptor file comprises a beginning portion of the video file including at least 2 seconds of display of the file. Optionally, managing the storage unit of the first computer comprises storing the selected blocks on the storage unit of the first computer. Optionally, the file comprises a video file and wherein the first computer begins to display the file before all the selected blocks are stored on the storage unit of the first computer.

There is further provided in accordance with an exemplary embodiment of the invention, a method of storage management of a video file, comprising determining for a plurality of peer computers in a communication network of a first computer, information on the storage management of blocks of the file by the peer computers, selecting blocks of the file to be stored locally on a storage unit of the first computer, responsive to the determining for the plurality of peer computers, storing the selected blocks on the storage unit of the first computer; and displaying the video file by streaming the blocks not selected to be stored locally from the plurality of peer computers in real time. The displaying of the video file optionally begins before all the selected blocks are stored on the storage unit of the first computer.

Optionally, the blocks of the file are downloaded for display, and the selected blocks are stored locally when they are downloaded for the display. Optionally, the blocks of the file are downloaded for display substantially in the order of the display, and the selected blocks are stored locally when they are downloaded for the display. Optionally, the determining of the information on the storage management of blocks of the file by the peer computers and the selecting of the blocks to be stored on the first computer, are performed by the first computer.

There is further provided in accordance with an exemplary embodiment of the invention, a method of participating in sharing storage of a file in a peer to peer network, comprising determining, for a first computer, a group of second computers with which the first computer is to share the file, the group of second computers including fewer than all the computers in the network storing portions of the file; determining information on the storage of blocks of the file by the second computers; selecting blocks of the file to be stored by the first computer responsive to the determined information on the storage by the second computers, without relation to storage of the file by computers of the network not included in the group of second computers; and managing a storage unit of the first computer, such that only the selected blocks from the file are stored locally by the first computer.

Optionally, determining the group of second computers comprises receiving a list of computers storing portions of the file and selecting a sub-group from the list. Optionally, determining the group of second computers comprises determining a group including fewer than 500 computers. Optionally, determining the group of second computers comprises determining responsive to times at which the computers began to store portions of the file. Optionally, determining the information and selecting the blocks are performed by the first computer.

There is further provided in accordance with an exemplary embodiment of the invention, a method of downloading a file in a peer to peer network, comprising determining upload bandwidths of peer computers storing blocks of the file; determining a download bandwidth of a receiving computer; selecting transmission times of segments of the file to the receiving computer, responsive to the determined upload bandwidths and download bandwidth; and transmitting requests for segments of the file to a plurality of the peer computers, wherein the requests are designed to have the segments delivered at the selected transmission times.

Optionally, selecting the transmission times comprises selecting such that peer computers are not requested to upload a second file segment required after a requested first file segment before the first file segment is expected to be uploaded based on the uplink bandwidth of the computer. Optionally, transmitting requests for segments of the file comprises transmitting the requests at times selected responsive to the determined upload bandwidths and download bandwidth. Optionally, transmitting requests for segments of the file comprises transmitting requests including indications of the selected transmission times.

Optionally, transmitting requests for segments of the file comprises transmitting requests for a plurality of segments at different times, along with indications of the requested times. Optionally, transmitting requests for segments of the file comprises transmitting requests indicating for one or more segments that the requested computer is to be in standby to provide the segment in case the segment is not delivered on time by a different computer. Optionally, the method includes receiving responses to the requests indicating one or more segments for which the computer receiving the request may not be able to provide the segment on time. Optionally, selecting the transmission times comprises selecting such that the segments are delivered to the receiving computer substantially in an order of display.

There is further provided in accordance with an exemplary embodiment of the invention, a computer configured for peer communications, comprising a network interface configured for communication with other computers; a storage unit; and a processor configured to determine for a plurality of peer computers, information on the storage management of blocks of a file by the peer computers, to select blocks of the file to be stored on the storage unit responsive to the determined information and to store the selected blocks in the storage unit.

Optionally, the processor is configured to transmit through the network interface requests from peer computers to store the blocks of the file not selected for local storage. Optionally, the processor is configured to transmit through the network interface requests from peer computers to commit to store the blocks of the file not selected for local storage. Optionally, the storage unit comprises a hard disk drive.

There is further provided in accordance with an exemplary embodiment of the invention, a computer configured for peer communications, comprising a network interface configured for communication with other computers; and a processor configured to determine for a plurality of peer computers storing segments of a file, the uplink bandwidth of the peer computers, to determine the downlink bandwidth of the network interface, to select transmission times of segments of the file to the computer for a plurality of peer computers, responsive to the determined upload bandwidths and download bandwidth, and to transmit requests for segments of the file to a plurality of the peer computers, which requests are designed to have the segments delivered at the selected transmission times.

Optionally, the processor is configured to receive responses to the requests from peer computers and accordingly to select corrected transmission times. Optionally, the processor is configured to transmit requests including an indication that the recipient is in a standby status for a segment of the file.

There is further provided in accordance with an exemplary embodiment of the invention, a method of participating in sharing storage of a file, comprising receiving, by a first computer, an instruction to share a file, comprising a plurality of blocks, assigning a score indicative of an extent of participation of the first computer to the storage of one or more files in the network, selecting blocks of the file to be stored by the first computer, responsive to the assigned score; and managing a data storage unit of the first computer, such that only the selected blocks from the file are stored in the data storage unit of the first computer.

Optionally, assigning the score and selecting the blocks are performed by the first computer. Optionally, assigning the score comprises assigning a score indicative only of an extent of storage of the file for which the instruction to share was received by the first computer.

### BRIEF DESCRIPTION OF THE DRAWINGS

The present invention will now be described in the following detailed description of exemplary embodiments with reference to the attached figures. These Figures are schematic illustrations only. Generally, only structures, elements or parts that are germane to the discussion are depicted.

FIG. 1 is a schematic illustration of a peer-to-peer network in which file sharing may be implemented, in accordance with an exemplary embodiment of the invention;

FIG. 2 is a schematic block diagram of a modular structure of a sharing process, in accordance with an exemplary embodiment of the invention;

FIG. 3 is a flowchart of acts performed by a sharing process in controlling shared storage of a file, in accordance with an exemplary embodiment of the invention;

FIG. 4 is a flowchart of acts of a sharing process performed in deciding which blocks of the file are to be stored locally, in accordance with an exemplary embodiment of the invention;

FIG. 5 is a flowchart of acts of sharing process performed in deciding which blocks of a file are to be stored locally, in accordance with another exemplary embodiment of the invention; and

FIG. 6 is a flowchart of a method of file retrieval from a distributed storage system, in accordance with an exemplary embodiment of the invention.

### DETAILED DESCRIPTION OF SOME EMBODIMENTS

### Network Overview

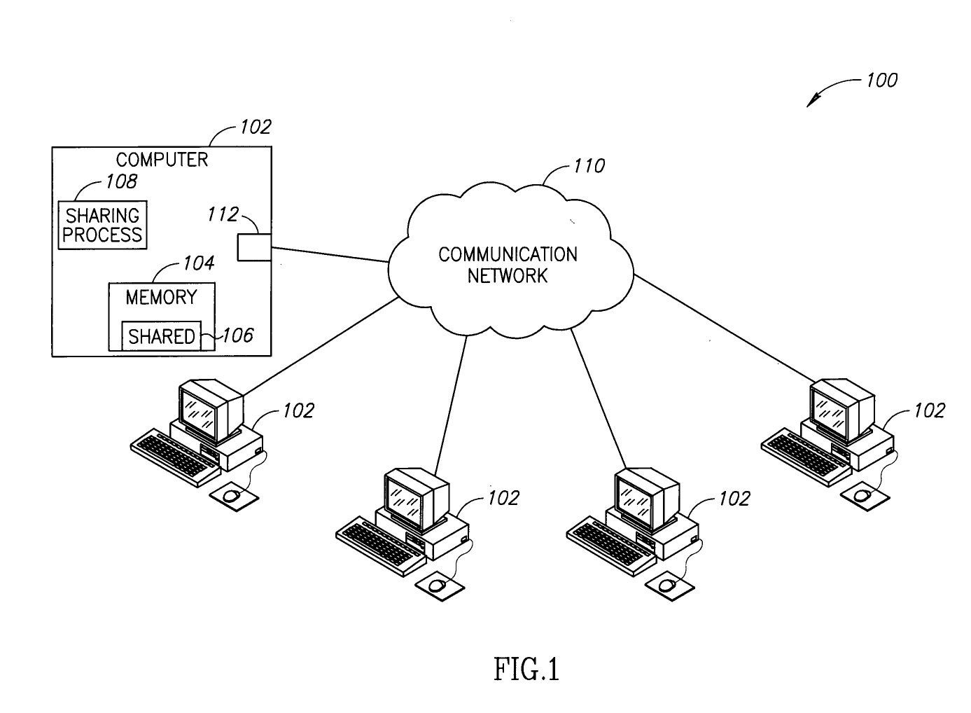

FIG. 1 is a schematic illustration of a peer-to-peer network 100 in which file sharing may be implemented, in accordance with an exemplary embodiment of the invention. Network 100 includes a plurality of computers 102, having memory units 104 (e.g., a hard disk, magnetic memory device, optical memory, flash memory), which include a shared region 106 in which files to be shared on network 100 are stored. A sharing process 108 is executed on each of computers 102, to facilitate file sharing. Shared regions 106 of computers 102 may all have the same size or the shared regions 106 of different computers 102 may have different sizes and/or may occupy different relative portions of their respective memory units 104. In some embodiments of the invention, shared region 106 of one or more computers 102 may include substantially the entire area of memory unit 104, used for data storage.

Computers 102 are connected to each other through a communication network 110, such as the Internet, a private IP network (e.g., an Intranet), a cable network, a wireless network (e.g., GPRS), a peer-to-peer network and/or a satellite network (e.g., DBS). Network 110 may be a local area network (LAN), a wide area network and/or any other type or scale of network. Each of computers 102 includes a network adapter 112 for communicating with other computers 102 in the network. The communication between individual computers 102 may be direct or indirect through one or more intermediate computers 102. The communications within network 100 may be performed in a secure or in a non-secure manner as deemed appropriate. Signals exchanged between computers 102 to manage file sharing may be encrypted, for example using a key exchange mechanism, and/or methods designed to protect against man-in-the-middle attacks. Computers 102 may be continuously connected to each other, or some or all of the computers may disconnect occasionally, intermittently and/or periodically from the network. For example, some users may connect their computer 102 to the Internet only during certain hours or may shut down their computer or block it from access, over weekends and/or on vacations.

The participating computers 102 may be general purpose computers and/or may be specific computers dedicated to performing specific tasks. For example, some or all of computers 102 in network 100 may be dedicated digital video recorders (DVR) which share some or all of their storage areas in storing video files. In another exemplary embodiment, some or all of computers 102 comprise mobile devices, such as cellular phones, media players, personal digital assistants (PDA) or portable computers.

The addressing, peer communication and file look up, as well as other management aspects of peer to peer network 100 may be performed using substantially any method known in the art, including, but not limited to, those described in the above mentioned patent publications, particularly US patent publications 2006/0294571 and 2006/0242155.

In some embodiments of the invention, sharing processes 108 on computers 102 manage distributed storage of files in network 100. In an exemplary embodiment of the invention, in storing a file, each block of the file is stored on a plurality of computers so that it is available for fast retrieval by other computers.

### Files

The files shared in network 100 may include any of a large range of information, such as movies, sound files, animation, TV programs, games and software.

In accordance with some embodiments of the invention, files stored by peer-to peer network 100 are broken up into blocks, and each block is stored by one or more computers 102, promising to store the block and provide it or segments thereof to computers 102 requesting segments of the block. In some embodiments of the invention, for each block, commitments are received from a plurality of computers, e.g., at least 8 or even at least 12, to ensure sufficient redundancy. Based on promises received from the other computers, a user can be assured with a relatively high level of certainty that a desired file will be available for use whenever desired, without the user having to store more than a small portion, optionally less than 10% or even less than 5% of the file, on his own computer 102.

Optionally, files are broken into blocks of substantially the same size, having a maximal size difference of less than 10%, less than 2% or even less than 0.5%. Alternatively, blocks may differ substantially in size, some blocks being even twice the size of other blocks. This alternative may be used, for example, when it is advantageous to divide a file into logical subsections. The number of blocks into which a file is divided is typically a compromise between a large number allowing flexibility in distribution of the file and a smaller number which reduces the complexity of the sharing protocol. Optionally, the file is broken up into less than 250 blocks, or even less than 180 blocks. In some embodiments of the invention, the file is broken up into at least 50 blocks or even at least 100 or at least 120 blocks. In an exemplary embodiment of the invention, files are broken up into at most 160 blocks. Optionally, video files are divided into blocks corresponding to up to 1 minute of display time.

Each block is optionally broken up into separately identifiable segments which can be requested and transmitted separately. The segments are optionally of sizes selected for ease of transmission and handling. Each segment is optionally of a size greater than 50 KB or even greater than 100 KB. Optionally, the segments are smaller than 5 Mbytes or even smaller than 1 Mbytes. In some embodiments of the invention, the segments have sizes which allow delivery within a short period, for example between 0.5-1 seconds. In an exemplary embodiment of the invention, in video files, each segment corresponds to up to 0.5 seconds of display.

### Sharing Process Structure

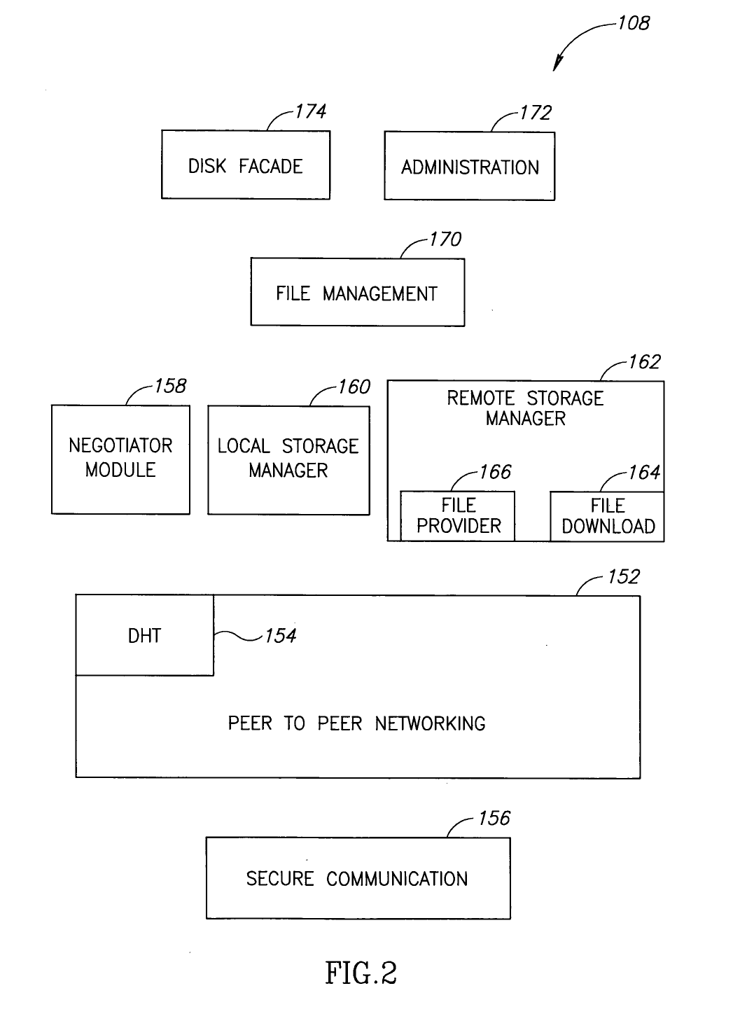

FIG. 2 is a schematic block diagram of a module structure of sharing process 108, in accordance with an exemplary embodiment of the invention. Sharing Process 108 optionally includes a peer to peer networking unit 152, which manages communication with other sharing processes 108 of other computers 102. Peer to peer networking unit 152 may include a distributed hash table (DHT) unit 154, in embodiments using DHT. Optionally, a secure communication unit 156 manages encryption and/or other security related issues of communication. A negotiator module 158 manages receiving commitments to store file blocks, from other computers. A local storage manager 160 determines which file blocks are stored locally. A remote storage manager 162 keeps track of the storage of file blocks stored on other computers, required by the present computer. A file download unit 164 manages the retrieval of file blocks from other computers and a file provider 166 manages the supply of file segments to other computers. A file management unit 170 is configured to handle removal or fetching of file blocks, controlling remote storage manager 162 and local storage manager 160. In some embodiments of the invention, a disk facade module 174 manages the user interface of the shared file, such that the distributed storage is transparent and as presented to the user, it appears as if the files are located in their entirety in dedicated data storage facilities of the local computer. An administration unit 172 optionally manages the operation of all the modules of sharing process 108. Alternatively or additionally, administration unit 172 performs logging and/or error correction and/or generates log reports, for example for submission to a central administration unit.

It is noted that the various modules described above as belonging to sharing process 108 may alternatively be implemented by a plurality of different processes and/or may be implemented by fewer or a different module division.

In some embodiments of the invention, sharing process 108 is implemented in secure code which is protected from alteration by users, so that the users cannot affect the process to operate in their favor. For example, sharing process 108 may be provided to users only after compilation. Alternatively, sharing process 108 is provided as open code. In some embodiments of the invention, in accordance with this alternative, peer data, such as scores are stored on computers other than the computer to which the data pertains and these other peers are required to acknowledge, periodically, that the data is correct. In an exemplary embodiment of the invention, a method such as that used in BarterCast is used for peer verification of data. Alternatively or additionally, sharing processes 108 verify that the data provided by peer computers is correct by recalculating the data from the raw values. In some embodiments of the invention, a voting method is used.

### File Sharing

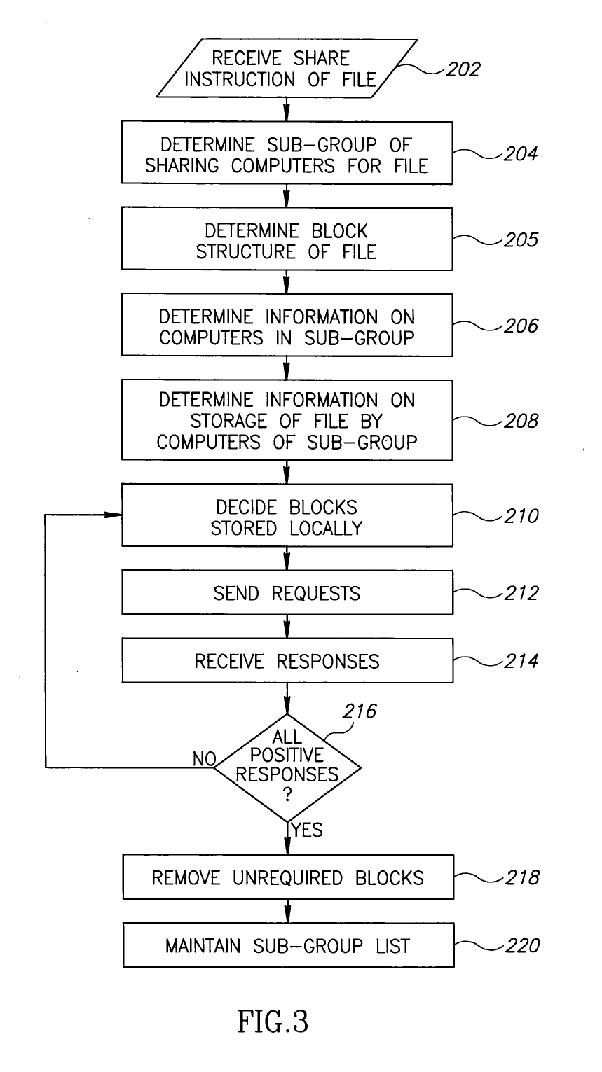

FIG. 3 is a flowchart showing acts performed by sharing process 108 in controlling shared storage of a file, in accordance with an exemplary embodiment of the invention. Upon receiving (202) an instruction to share a file, typically from a human user, sharing process 108 determines (204) the identities of a plurality of computers 102 already participating in the sharing of the file, which generally is a sub-group of the computers 102 in network 100. In addition, sharing process 108 determines (205) the block structure of the file.

For each of the determined computers 102 in the sub-group, sharing process 108 determines (206) general information concerning the computer 102. In addition, sharing process 108 determines (208) particular information on the storage of the file by the computers in the determined sub-group. Responsive to the collected information, sharing process 108 decides (210) which blocks of the file it will store locally in its shared region 106 and which computers 102 will be requested to store which blocks of the file. Sharing process 108 then sends (212) block storage requests to the selected computers and receives (214) their responses.

If (216) negative responses were received, the deciding (210) is optionally repeated, regarding some or all of the blocks for which a negative response was received, and additional requests are optionally transmitted to computers 102. In some embodiments of the invention, the deciding (210) is repeated only if the negative responses have a substantial effect on meeting the minimal storage requirements of the blocks. Optionally, if even with the negative responses taken into account an adequate number of commitments to store are received for each of the blocks, the deciding (210) is not repeated. Alternatively, the deciding (210) is repeated if it results in an unfair load on the determining computer. Optionally, if negative responses causing the number of commitments for a block to go under an allowed minimum, are received, the determining computer stores a copy of the block. If the determining computer ends up storing substantially more than its share in accordance with an equal distribution, the deciding (210) is repeated.

After receiving satisfactory responses, sharing process 108 optionally removes (218) the blocks that it is not required to store from memory unit 104 of its computer, so as to make room in the memory unit for other files. Sharing process 108 optionally maintains (220) a list of the sub-group with which the file is shared together with information allowing fast retrieval of portions of the file, when desired. The method of FIG. 3 is optionally designed to be implemented from start to finish within less than 1 second, including the negotiations with the peer computers.

### Beginning State

The sharing of a file may be initiated by a user having a copy of the file. In such a case, the sharing process 108 of the user's computer optionally searches for other computers storing the file and attempts to reach agreements with the other computers on sharing the storage of the file, in order to allow removing some portions of the file from the local storage. Another possibility is that the sharing process is initiated by a user who does not have a copy of the movie and is interested in making the file available from the user's computer for subsequent use. Sharing process 108 in this case optionally reaches agreements with other computers as to which blocks of the file it will store for other computers and which file blocks will be stored by other computers and then downloads only those blocks that it needs to store. In some scenarios, the user not having a copy of the file is interested in viewing the file immediately in real time, without waiting for download of the entire file to the local computer 102. Optionally, in such scenarios, if a sufficient number of other computers are storing blocks of the file, the file is downloaded in real time and those portions of the file that the computer needs to store are saved in the local memory unit 104 for later use, while the rest of the portions are discarded.

It is noted that if the number of computers already storing portions of the file is insufficient, real time download and viewing may not be possible. Optionally, in such cases, sharing process 108 determines which blocks can be downloaded in real time, and downloads the blocks that cannot be downloaded in real time, from a server and/or using non-real time peer-to-peer download methods. Thereafter, the user can download the remaining portions of the file in real time while using the file. Optionally, sharing process 108 provides an estimate of the time required until the file will be available for real time retrieval.

In some embodiments of the invention, when a file is available only on a limited number of computers, a computer may request to join a sharing scheme of a file, but cannot do so together with a real time download of the file. Optionally, if a content provider is interested in fast distribution of a file, the content distributor can load the file onto a plurality of servers, e.g., 200 servers, which act as peers in a peer network. The first real client to request to download the file may thus already find a sufficient number of clients sharing the file, such that the file can be downloaded in real time while it is being shared. In some embodiments of the invention, once the servers acting as peers determine that there are a sufficient number of peers storing the file, the servers begin to delete the file from their local storage and leave the sharing scheme. The storage space of the servers and their bandwidth is thus made available for other uses, including delivery of other files through the peer network.

While the plurality of servers may be implemented by a plurality of separate machines, in some embodiments of the invention, a single hardware machine is used to implement a plurality of servers. For example, a hardware computer with a large storage and upload bandwidth may carry software which implements, more than 5, more than 10 or even more than 200 separate peer computers.

In some embodiments of the invention, each file shared by the peer-to-peer network is represented by a descriptor file, which includes identifications of its blocks and their sizes. Optionally, the blocks are identified by a unique address or signature (e.g., a 160 bit signature as known in the art). In addition to the block structure, the descriptor optionally includes a beginning portion of the movie, as discussed hereinbelow in detail.

When a computer provides a file for sharing, the sharing process 108 of the computer optionally generates the descriptor. Optionally, the descriptor generation process is defined strictly, such that all computers generating a descriptor for the same file will generate the same descriptor, for example using a hash function. Other computers interested in sharing the file optionally download the descriptor to their computer. In some embodiments of the invention, upon downloading a descriptor, sharing process 108 immediately and/or automatically performs a sharing process for the file.

In some embodiments of the invention, for example in relation to video files, a user wishing to view a video file, downloads its descriptor. Upon downloading the descriptor, the video file begins to be displayed using tables of the sharing process, and in parallel, the sharing process is performed. Thus, in some embodiments of the invention, the display of the video in accordance with the sharing process begins before the computer actually has the blocks it is supposed to store in accordance with the sharing scheme. These blocks will be downloaded before they are required for display.

### Providing Instruction

Referring in detail to receiving (202) an instruction to share the file, in some embodiments of the invention, placement of a file in shared region 106 by a human user is considered an implicit instruction to share the file. The file placed in shared region 206 may originate from substantially any source, including self-created, provided from a DVD, CD, flash memory or any other portable storage unit or downloaded from the Internet using any method known in the art (e.g., peer to peer sharing, streaming, download). Alternatively, the user provides an explicit instruction to share the file. In some embodiments of the invention, a user may request to share a file that is not available on the user's computer 102. For example, the user may find reference of a file in a catalog of files stored on the peer-to-peer network 100 and request to be included in the sharing scheme of the file. In such a case, rather than removing (218) blocks not needed, sharing process 108 will download blocks that it needs to store to its shared region 206. Optionally, a user request to view a file hosted by peer-to-peer network 100 in real time is considered as an implicit instruction to include the requestor in the sharing scheme of the file. In some embodiments of the invention, if possible, the sharing process will be performed and will be used immediately to download the file in real time. But if the real time download is not possible, the sharing process will be performed and the blocks determined to be stored locally will be downloaded in a manner which allows viewing the file in real time at a later time.

In some embodiments of the invention, when a user provides an instruction to share a plurality of files, the order in which sharing process 108 handles the files is based on their order in the instruction. Alternatively or additionally, the order of handling the files, for files already involved in an initial haring scheme, is based on the percentage of the file stored locally. Optionally, files having a larger share stored locally are handled first, in order to reduce the percentage of the file stored locally.

### Cluster Selection

As to determining (204) the identities of the plurality of computers 102 already participating in the sharing, in some embodiments of the invention, the determination is performed using a distributed hash table (DHT) method. In other embodiments, the determination is performed by accessing a central index server (not shown) or one of a plurality index servers (not shown). Further alternatively, the determination is performed by transmitting broadcast query signals throughout the network. Other methods known in the art may alternatively be used to determine which computers 102 already participate in sharing a specific file.

In some embodiments of the invention, the determining (204) of a plurality of computers 102 participating in the sharing of the file does not necessarily result in determining all the computers 102 participating in the sharing of the file. Optionally, the determination results in up to a predetermined maximal number (M) of computers 102, in order to place a limit on the complexity of the further acts of the method of FIG. 3. The predetermined maximal number is optionally selected as a compromise between a relatively large number which allows each participant computer 102 to store a smaller percentage of the file and a smaller number which makes the management simpler, and reduces the amount of communications required to manage the file sharing. In some embodiments of the invention, the predetermined maximal number of computers 102 is smaller than 1000 or even smaller than 700. Optionally, on the other hand, the predetermined maximal number of computers 102 is greater than 100 or even greater than 200 or 300. In an exemplary embodiment of the invention, the predetermined maximal number of computers 102 is 500. In an alternative exemplary embodiment, the number of computers 102 is 200. Thus, in large networks and/or for popular files, a computer may manage sharing of a file with fewer than 1% or even fewer than 0.1% of the computers of the network that store segments of the file.

It is noted that the number of peer computers with which a specific computer may communicate is generally larger than the number originally included in the sub-group, as additional computers 102 joining the sharing scheme may make overtures to the specific computer. The number of peer computers with which a specific computer needs to communicate is however limited, in some embodiments of the invention, as when the specific computer is longer in the sharing scheme, it will not appear in the sub-group of computers joining the sharing scheme.

Rather than using a fixed value for the predetermined maximal number of computers 102, in some embodiments of the invention, the predetermined maximal number is selected responsive to the size of the file and/or responsive to one or more parameters of the computers 102 in the sub-group of the file. For example, a larger maximal number may be used for larger files and/or for files for which the other computers interested in sharing the file have a relatively low average uplink bandwidth. Optionally, for media files requiring real time delivery, the total uplink bandwidth of the computers is required to be at least a given number of times greater than required for streaming the file. In an exemplary embodiment of the invention, the total uplink bandwidth is required to be at least 20 times, at least 25 times or even at least 30 times greater than required for streaming the file.

In some embodiments of the invention, the predetermined maximal number of computers is selected responsive to the number of blocks in the file, for example at least twice, at least four times or even at least five times the number of blocks in the file.

In some embodiments of the invention, each computer 102 is associated with availability information and computers are added to the sub-group until at all times the sub-group includes at least a predetermined number of computers that are available. The availability information of the computers may be based on user input and/or may be based on actual feedback in response to attempts to contact the computer at different times of the day and/or on different days of the week.

When the number of computers 102 participating in the sharing of the file is greater than the maximal number, the determined (204) identities optionally include those computers (102) that most recently joined the sharing of the file. Selecting the computers 102 that recently joined the sharing of the file in this manner distributes the load between the computers, by always passing the load onto the newcomers. Alternatively, each computer is given a score denoting the number of computers 102 for which it belongs to the sub-group of the specific file or of all files and the determined (204) identities include the computers with the lowest scores. Further alternatively or additionally, the scores of the computers may relate to one or more additional parameters, such as the number of times the computer was required to upload a segment of the file to another computer. It is noted, however, that in some embodiments of the invention, for simplicity, the determined (204) identities are merely selected randomly. In an exemplary embodiment of the invention, the determined identities are selected randomly and/or based on proximity or any other parameter, from a group of computers most recently joining the sharing scheme. For example, 200 computers may be selected randomly from the 1000 computers most recently joining the sharing scheme. In some embodiments of the invention, the computers participating in the sharing are selected at least partially responsive to their distance from the determining computer, for example as determined based on topology (e.g., from the IP address) and/or based on round trip time (RTT).

The selection of computers participating in the sharing is optionally performed by the entity providing the identities of the computers sharing the file, e.g., the DHT mechanism. Alternatively, the DHT or other entity managing a list of computers sharing the file provides a complete list of computers to sharing process 108, which selects from the list the computers to be included in its sharing cluster. Further alternatively, the selection of computers is performed both by sharing process 108 and the entity providing the list of computers. For example, the entity providing the list may provide two, four or five times the maximal number of required computers and sharing process 108 selects therefrom the computers to be used.

In an exemplary embodiment, a file that requires 1 Mbps to stream is required to have a group having a total uplink bandwidth of at least 30 Mbps. The group provided by a DHT mechanism is optionally much larger, for example 3 or 4 times greater, optionally including about 1200 computers having an average upload bandwidth of 100 Kbps. Sharing process 108 selects 300 computers from the list, having together an upload bandwidth of about 30 Mbps.

In some embodiments of the invention, if fewer than a predetermined minimal number of computers 102 are registered as being interested in sharing the file, the instruction to share the file is rejected. The minimal number is optionally greater than 10 or even greater than 25 (e.g., 30), as with fewer participating computers, each computer will be required to store at least 25% of the file. In some embodiments of the invention, the minimal number is smaller than 1000 or even smaller than 400. It is noted that a minimal number is not necessarily applied and that the sharing may be performed between 2 computers, even if the result is that both computers store all the blocks, as this sharing scheme serves as a platform for additional peers to subsequently join in the sharing.

### General Information

The determined (206) general information for each computer optionally includes one or more measures of the upload bandwidth of the computer and/or information on the availability of the computer, such as the times of day and/or days in the week and/or month in which the computer is inoperative. Alternatively or additionally, the general information includes a general score of the computer not related to a specific file. In some embodiments of the invention, the general information includes a round trip time (RTT) of messages transmitted from the computer to various peer computers and/or other location and/or distance related information.

In some embodiments of the invention, each computer is associated with a parameter indicating a maximal number of peers to which it can commit to store a single block. Limiting the number of peers to which a block is committed at once reduces the chances of a plurality of peers requesting the block at once in a manner which prevents the peer computer from responding to the requests. Alternatively to using a general maximal number of peers for all files, each file is associated with a separate maximal number of peers for which a computer can commit to store a block, for example based on the size and/or priority rating of the file. Further alternatively, the maximal number of peers to which a computer can commit to store a block is universal and is the same for all computers.

### File Information

As to determining (208) particular information on the storage of the file by the computers in the determined sub-group, sharing process 108 optionally manages a table which lists for each block of the file, for each computer 102 in the sub-group of the file, the status of the block in the computer. In an exemplary embodiment of the invention, the status may be one of the following:

1) stored and committed—the block is stored by the computer and the computer has committed to another computer that it will maintain the storage;

2) stored but not committed—the block is stored but the computer is not committed to store it and may discard the block at any time

3) not stored—the computer does not store a copy of the block

4) required—the computer is interested in more peers that will store copies of the block. For example, the number of peers storing each block may be required to be within a predetermined range, such as between 10 and 13 peer computers. As long as the upper level is not reached for a block, the computer indicates that it wants more commitments for the block. In some embodiments of the invention, required blocks are always blocks not stored by the computer. In other embodiments, however, a block may be required even if the computer stores a copy of the block, for example when the computer is attempting to drop its copy of the block.

The status may be indicated by several binary values, or by a level indication, such as stating the number of computers to which the computer has committed to store the block or by stating whether the file is highly (H) required or only required to a low (L) level.

An exemplary table may have the form illustrated by the table below, in which V indicates that the computer has an uncommitted copy, numbers indicate the number of computers to which a block is committed, H indicates a block is required to a high extent, L indicates a block is required only to a low extent and a “−” indicates that the computer does not store or require the block:

Computer

| Block | 1 | 2 | 3 | 4 | 5 | 6 |
|---|---|---|---|---|---|---|
| 1 | 13 | 2 | — | — | 7 | — |
| 2 | V | — | — | — | — | V |
| 3 | — | V | — | H | H | — |
| 4 | 5 | — | 10 | 20 | — | 30 |
| 5 | — | 17 | — | — | 40 | — |
| 6 | 40 | — | — | 32 | — | — |
| 7 | H | — | — | — | — | — |
| 8 | L | 40 | — | V | L | — |

It is noted that rather than storing all the information in a single table, the information may be stored in separate tables, for example separate tables indicating whether the block is committed, whether the block is stored and whether the block is required.

The file information optionally also includes a score assigned to each of the computers 102 participating in sharing the file. This score represents the extent to which the computer stores portions of the file. Optionally, the score of each computer represents the extent to which the computer commits to store blocks for other computers. In an exemplary embodiment of the invention, the score represents the difference between the extent to which the computer commits to store blocks for other computers and the extent to which the computer requested from other computers to commit to store blocks on its behalf.

In some embodiments of the invention, a specific computer 102 can ask a peer computer to commit to store a block of a file for it, only if the requested computer is already committed to store the block for another computer or the score of the requesting computer is higher or not lower than the score of the requested computer.

Further information on the file for a specific computer optionally includes the time at which the computer joined the sharing scheme of the file.

The information is optionally determined (206, 208) from messages received from the peer computers of the sub-group of the file. Optionally, after determining (204) the sub-group, sharing process 108 sends a message to each of the peers in the group, requesting the information. Alternatively or additionally, the information is received from one or more of the peers and/or from a general server, that previously collected the information. Other methods for collecting information from peers in a network may also be used.

Deciding which Blocks to Store

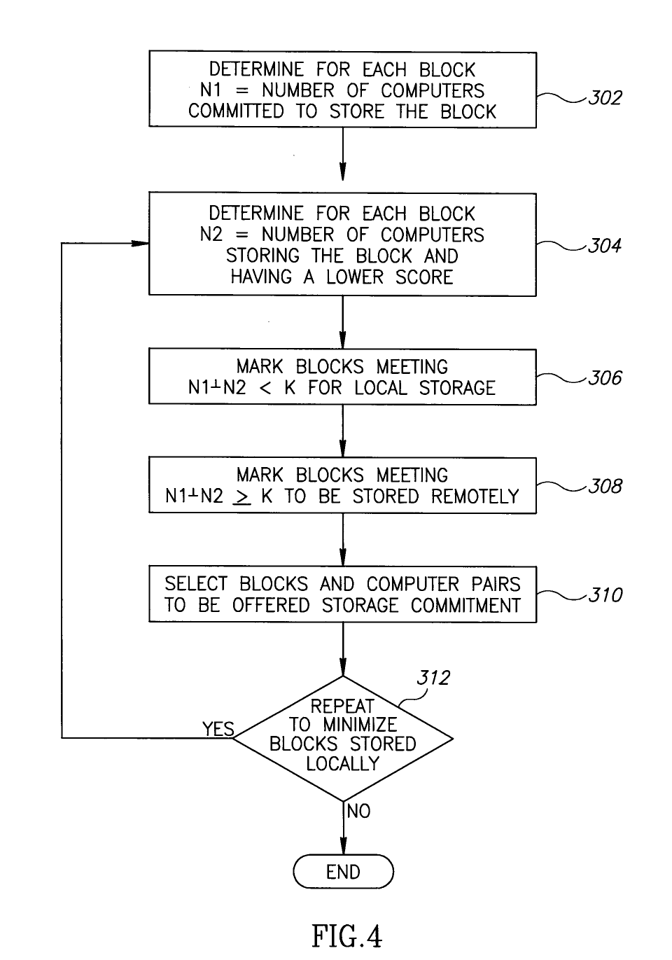

FIG. 4 is a flowchart of acts of sharing process 108 performed in deciding (210) which blocks of the file will be stored locally, in accordance with an exemplary embodiment of the invention. Sharing process 108 reviews the table of the file to determine (302) for each block, the number (N1) of computers 102 which are committed to store the block for other computers. For blocks for which a minimal number (K) of committed computers were not found (N1<K), sharing process 108 determines (304) the number (N2) of computers 102 that have the block stored thereupon without being committed to store it and have a lower score than the computer running the sharing process 108. Blocks for which N1+N2<K, are marked (306) to be stored locally by the computer. The blocks for which N1+N2≧K are marked (308) to be requested to be stored by the other computers already storing the block. Optionally, for one or more of the blocks determined to be stored locally, sharing process 108 selects (310) other computers to which it will offer to commit to store the block for them. Such offering increases the score of the computer 102 and thus may increase N2 and the number of blocks that do not need to be stored locally. Optionally, the determination (304) of N2 and the selection (310) of block commitments are repeated until (312) a minimal number of blocks are required to be stored locally.

In some embodiments of the invention, the minimal number (K) of computers required to store each block is a fixed number chosen globally for all files, based on a general rule allowing for sufficient redundancy to cope with cases wherein several of the computers storing a specific block are not available when the block is required and/or the computers are overloaded. On the other hand, the redundancy should not be superfluous, so as not to require an excessive amount of unnecessary duplicate storage. The minimal number of computers K is optionally selected based on empirical information on the probability that a segment will be requested, with an appropriate safety factor included.

Optionally, the minimal number of computers (K) required to store each block is at least 2% or even at least 4% of the maximal number (M) of computers in the sub-group of the sharing scheme. The minimal number of computers (K) required to store each block is optionally less than 10%, less than 8% and optionally even less than 6% of the maximal number (M) of computers in the sub-group. In an exemplary embodiment of the invention, the minimal number (N) of computers required to store each block is 10.

Alternatively to using a fixed number for K, K may be set dynamically according to the size of the file, its importance rating and/or one or more parameters of the computers in the sub-group and/or the computers actually storing the block. The one or more parameters of the computers may include, for example, their upload bandwidth, a score, their availability and/or their distance from the determining computer.

In some embodiments of the invention, the value of K may be configured and/or adjusted by the user. For example, a user may decide whether the file should be available in real time, in which case a relatively high K is selected, or is only required within a longer period, in which case a lower K is used. Foregoing the real time delivery, the amount of data needed to be stored locally may be very small, for example as low as less than 0.5% or even less than 0.2% of the entire file. For example, for storing a video file of 4 Gbytes, the computer may be required to store locally as little as 4 Mbytes, although for real time delivery a higher size, possibly greater than 30 Mbytes, is expected.

Alternatively or additionally to requiring at least a specific number of computers, the computers storing each block are required to have a combined uplink bandwidth at least sufficient to allow delivery of the file at a required rate, e.g., at a real time rate. Optionally, the combined uplink bandwidth of the computers storing each block is required to be at least twice, at least 2.5 times or even at least three times the rate at which the file needs to be delivered to the client, e.g., a rate required for real time use of the file. In an exemplary embodiment of the invention, at least 10 computers are required to store each block and the computers storing the block are required to have an uplink bandwidth at least 3 times the required bandwidth for real time display of the file.

In some embodiments of the invention, a computer is limited to committing to store a block for up to a maximal number of computers, in order to minimize the chances that the computer will be requested to provide the block to two or more computers to which it committed to store the block, at the same time. The maximal number may be fixed, for example 40 or 50, or may depend on the uplink bandwidth and/or some other parameter of the computer. If a computer is committed to the maximal number of computers it is allowed to commit to, sharing process 108 optionally relates to that computer as if it does not have the block at all, as it is not permitted to commit to store the block in any event.

In some embodiments of the invention, an upper limit Kᵤ is defined for the number of computers committed to store each block. If N1+N2>Kᵤ, sharing process 108 selects a sub-group of Kᵤ computers to be requested to store the block. Optionally, preference is given in the selection to computers committed to store the block for other computers. Alternatively or additionally, preference is given to computers with a lowest score, indicative of less contribution to the storage of the shared file. Further alternatively or additionally, preference is given to computers storing a smallest number of blocks and/or having some other characteristic. In some embodiments of the invention, the selection of the sub-group of Kᵤ computers is performed at least partially randomly. Alternatively or additionally to defining a fixed upper limit, the upper limit may depend on the uplink bandwidth of the selected computers, optionally requiring at least 3 times the bandwidth required for real time delivery of the file.

In some embodiments of the invention, the number of computers storing a block not stored locally is required to be within a given range, e.g., 10-13, and/or the computers storing the block are required to have an uplink bandwidth within a specific range, e.g., 2.5-3 times the required bandwidth. Optionally, during the internal deciding (210) by sharing process 108, the upper limit is required in order to decide not to store the block locally. However, after actually communicating with the peer computers, if positive responses were received from at least the lower limit, the deciding (210) is not repeated. Optionally, only if the computers storing the block go below the lower range, does the computer take action to receive more commitments or to store the block locally. Thus, the sharing process has a measure of stability and does not fluctuate with each loss of connection with a single computer. In some embodiments of the invention, for blocks not reaching the upper limit, sharing process 108 indicates to peer computers performing the sharing scheme that it desires commitments. As to selecting (310) other computers to be offered commitment to store blocks for them, optionally the selection is performed by determining which blocks the computer will have to store and offering to commit to store these blocks. If, however, these blocks are insufficient, sharing process 108 selects one or more additional blocks characterized by having a largest number of computers indicating they are interested in more computers to store the block. Optionally, preference for local storage is given to blocks that are requested by the largest number of peer computers.

In some embodiments of the invention, in which peer computers indicate a degree to which they require commitment of a block, sharing process 108 first offers files to computers requiring the commitment to a high extent and only if need remains to provide more commitments does sharing process 108 offer to commit to computers indicating a low degree of need for storage commitment of the block. In some embodiments of the invention, in order to offer commitment of a block to a computer indicating a low degree of need for the block, the offering computer has to have at least a predetermined score relative to the computer receiving the commitment.

In some embodiments of the invention, each computer is allowed to commit to store only up to a predetermined percentage of the blocks of the file, in order to prevent a computer from being over committed. Optionally, a computer is allowed to commit only for up to 20% of the blocks of any file.

### Sharing Score

A sharing score of the file is optionally managed for each computer sharing the file, in order to facilitate management of the fairness of the distribution of the file storage. Optionally, the score is incremented by a score point for each (block, computer) pair, for which sharing process 108 commits to store the block for the computer. The score is optionally reduced by a point for each (block, computer) pair, for which sharing process 108 requested the computer to commit to store a copy of the block. Alternatively, the score relates to the number of blocks stored and not to the number of computers storing the block. Further alternatively, different blocks receive different numbers of points, for example according to the sizes of the blocks and/or their importance. Alternatively or additionally, different computers receive different numbers of score points, in accordance with their operational parameters, such as availability time and/or uplink bandwidth. Optionally, the number of score points received for each block commitment increases with the uplink bandwidth of the computer providing the commitment.

In some embodiments of the invention, each computer is allocated a predetermined number of score points at the beginning of the sharing process, to allow the computer some leeway in providing less storage service than it receives.

In a simple embodiment of the invention, the score of sharing process 108 is kept at a fixed value throughout the sharing process of the file and is updated only after the sharing is completed. Optionally, in accordance with this embodiment, sharing process 108 is required to manage its commitments and requests for commitments in a manner to prevent the score from dropping below a predetermined minimum value.

In a more complex embodiment of the invention, the score of each computer is continuously updated throughout the sharing process, so that the score is accurate throughout the negotiations. Accordingly, sharing process 108 selects the computers from which it requests commitment of storage of blocks and the order in which it requests commitments so that at the time of each request the requesting computer 102 will have a sufficient score warranting the commitment.

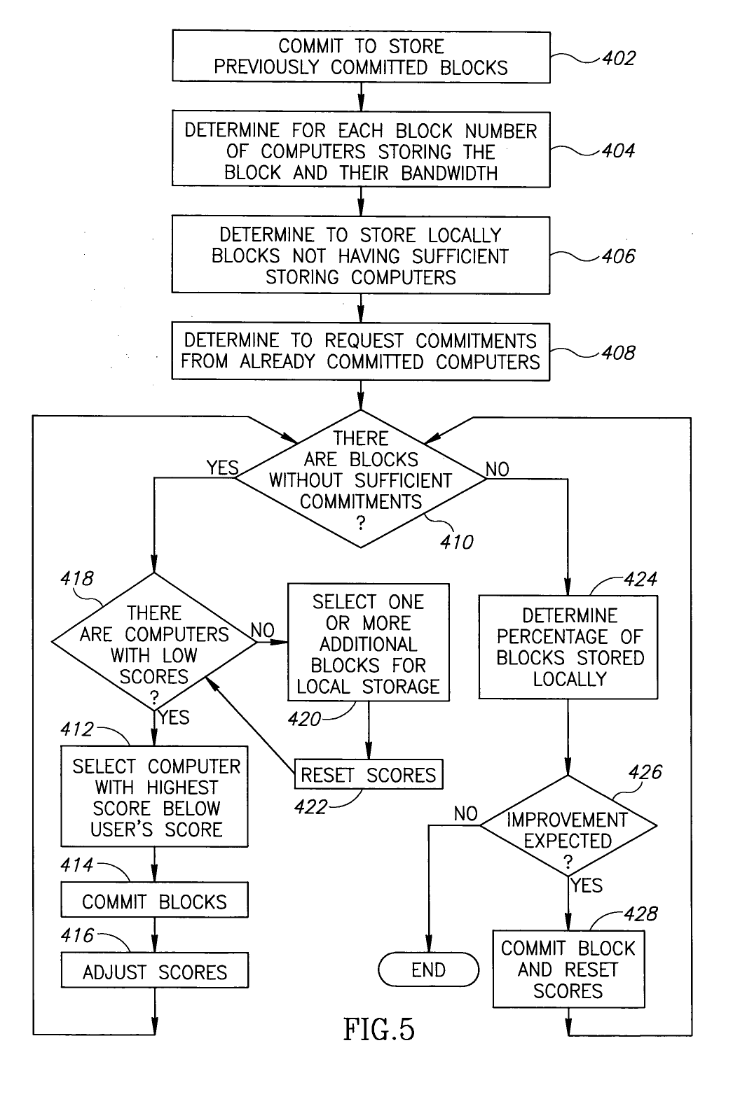

FIG. 5 is a flowchart of acts of sharing process 108 performed in deciding (210) which blocks of the file will be stored locally and which computers will be requested to commit storage of blocks, in accordance with an exemplary embodiment of the invention. Optionally, sharing process 108 determines to commit (402) to store any block that is already committed to one or more other computers, to as many as possible peer computers 102 indicating that they are interested in more commitments for the block, in order to collect more score points. Thereafter, for each block, sharing process 108 determines (404) the total number of computers storing the block and the total uplink bandwidth of the computers storing the block. Blocks for which the total number of computers and/or their bandwidth do not reach a required minimum, are determined (406) to be stored locally and are removed from further consideration.

For each of the remaining blocks, sharing process 108 determines (408) to request from computers 102 already committed to store the block for other computers, to commit to store the block for the deciding computer. These requests are performed without reducing the score, as in this embodiment they can be performed after other requests regardless of the score.

If (410) there are blocks that are not determined to be stored locally or have a sufficient number of committing computers, sharing process 108 determines whether (418) there are peer computers with lower scores than the deciding computer. If (418) there are such peer computers with lower scores, the peer computer with the highest score below the score of the deciding computer is selected (412) and a block that it has stored is committed (414) to the deciding computer. For each commitment, the score of the committing computer is increased (416) and the score of the deciding computer is decreased. If (418) there are no more peer computers with lower scores, sharing process 108 selects (420) one or more additional blocks to be stored locally, resets (422) the scores and repeats the determination of whether all the other blocks can achieve a sufficient number of commitments.

When (410) all blocks are determined to be stored locally or have sufficient commitments, the percentage of blocks stored locally is determined (424) and if (426) improvement is expected, one or more blocks having a highest desirability for commitment by peer computers are committed (428) to be stored locally, in order to collect additional score points, and the determination of whether all the other blocks can achieve a sufficient number of commitments is repeated.

As to selecting (420) one or more additional blocks to be stored locally, in some embodiments of the invention, in each step only a single additional block is selected for local storage, to prevent excess storage when not necessary. Alternatively, larger steps are used, for example selecting more than 25%, for example about 50%, of the blocks that did not collect sufficient commitments. Optionally, the selected blocks are those that collected the smallest number of commitments.

Alternatively or additionally to determining (424) whether the results are sufficient based on the number of blocks stored locally, the number of blocks committed to be stored locally may be taken into consideration. Optionally, in determining whether improvement is expected, the percentage of blocks stored locally is compared to a static, such as an average percentage for many computers and/or files, and if the value is below the average or is only slightly above the average, the determination is not repeated. In some embodiments of the invention, if after a repeating round the proportion of blocks stored locally is not improved or is improved only slightly, the determination is not repeated.

As to committing (428) a block to be stored locally, optionally, a block with a highest number of computers requesting the block is selected to be committed. In some embodiments of the invention, the block to be committed is one that was determined to be stored locally and/or requires a relatively large number of score points to gather sufficient commitments.

Once a decision has been made as to which computers are to be requested to commit which blocks, sharing process 108 sends request messages to the peer computers. The messages are optionally sent in the order of the scores of the peers. First, messages are transmitted to peers that are given more commitments than they are requested to give, as these messages increase the score of the computer. Then, messages are transmitted to the remaining peer computers according to the order of the score, starting with the peer computer with the highest score and proceeding downward, so that the computer's highest score is used against the peer with the highest score. Alternatively, the messages are transmitted substantially simultaneously to the peers, but with score indications assuming that the previous requests were all answered positively. For example, if a computer has a score of 10 and its first message to computer A is supposed to reduce the score by 4 points, a message to computer B may be sent before a response was received from computer A, with a score of 6.

Alternatively to sending a single message including both commitment offers and commitment requests, sharing process 108 first sends messages with commitment offers, so as to accumulate as many score points as possible. Thereafter, sharing process 108 sends requests for commitments, according to the order of the scores of the peers.

### Alternative

Alternatively or additionally to using a score, each peer is required to store a predetermined percentage of the blocks locally. In an exemplary embodiment of the invention, the predetermined percentage is 20%. Optionally, instead of using a score, sharing process 108 notifies the peers which blocks it has determined to store and in exchange receives the commitments of the peers to store the other blocks.

### Sharing Review

In some embodiments of the invention, sharing process 108 periodically reviews the sharing schemes of its files and determines files for which the sharing scheme needs updating. Alternatively or additionally, the review is performed when the computer 102 has available bandwidth and/or processing time. For example, files for which the computer has a high score indicative of a high contribution of the computer to the storage of the file, may be determined to require updating of their sharing scheme, to reduce the number of blocks stored locally by the computer. Alternatively or additionally, the updating of the sharing scheme is performed for files for which the computer stores more than a predetermined percentage of the file, for example more than its share if all the peers in the sub-group store an equal portion (e.g., 3%). The sharing scheme update is optionally performed for the determined files in the order of importance of updating the sharing scheme, e.g., files with larger numbers of blocks stored locally are handled first.

Alternatively or additionally, the review of the sharing schemes of the files is performed in response to a user instruction and/or when the local memory unit 104 is loaded and it is desired to free some of the memory.

In some embodiments of the invention, sharing process 108 periodically (e.g., once every hour or several hours) checks whether the information in its maintained list for the file is up to date and updates the list accordingly. Optionally, in checking the information, sharing process 108 transmits messages to the computers that committed to store at least one block of the file on its behalf and receives notifications from them as to whether the commitments are still in force and/or as to the current parameters of the computer (e.g., uplink bandwidth). Alternatively or additionally, each computer is required to periodically transmit its status to other computers, without receiving a request. Optionally, a time out protocol, such as based on an exponential back-off algorithm, is applied by the receiving computers 102.

In some embodiments of the invention, sharing process 108 differentiates between computers that are unavailable for a short period, and computers not available for a long time.

Optionally, for short term unavailability for example, sharing process 108 intervenes only if the availability of one or more of the blocks of the file changes to below an allowed level. In such a case, the entire sharing process is invoked, or an abridged process is performed in which additional commitments to store blocks which have a low commitment registration are collected and, if necessary, sharing process 108 collects more score points by committing to store blocks for other computers and/or by storing one or more additional blocks.

Optionally, if a computer is determined to be completely unavailable for a long time or a computer actively leaves the sharing scheme of a file, for example due to a user decision to erase the file, the computer is removed from the list of computers participating in the sharing, managed by sharing process 108. Alternatively or additionally to removing the computer from the sharing scheme, an additional computer sharing the file is added to the sharing scheme of the computer performing the determination. Optionally, the additional computer is found by accessing the DHT and/or using any other method for determining which computers are sharing a specific file. In some embodiments of the invention, if there are no computers that can be added to the sharing scheme and the number of computers sharing the file decreases to a state in which the computer is required to store a large percentage of the file, the sharing scheme is stopped and each computer interested in having the file stores the entire file. Alternatively, the sharing scheme is lowered to a non-real time scheme in which fewer copies of each block are stored by different computers.

### Retrieval

The planned storage of blocks in sufficient numbers of computers 102, in embodiments of the invention designed for real time retrieval, allows for retrieval of files, such as video files, at a rate allowing real time use of the file. Computer 102 optionally continuously manages a table which lists for each block of the file which peer computers are committed to store the block.

In some embodiments of the invention, each computer 102 participating in sharing a file keeps a short beginning portion of the file on its computer. This short beginning portion is displayed when display of the file is requested, and suffices to allow sufficient time for retrieval of the first block of the file stored on a peer computer. In some embodiments of the invention, the short beginning portion is smaller than 5 Mbytes, smaller than 2 Mbytes or even smaller than 1 Mbyte. Optionally, the short beginning portion has a size smaller than 0.5% or even less than 0.2% of the entire file. In some embodiments of the invention, the short beginning portion is of a predetermined display length, optionally less than a minute or even less than half a minute display length. Optionally, the short beginning portion has a display length of at least 5 or even 10 seconds (e.g., 16 seconds). In some embodiments of the invention, a longer portion having a display length of at least 30 or even 60 seconds is used. Alternatively or additionally, the short beginning portion has a size of at least 50 Kbytes, at least 500 Kbytes or even at least 1 Mbyte. In some embodiments of the invention, the short beginning portion has a size of at least 5 Mbytes.

As the short beginning portion is stored on all computers it is not included in the sharing scheme. Alternatively, as some computers may prefer to wait an extra time until the video can be displayed rather than store the beginning portion, the short beginning portion is considered as a block of the sharing scheme. Further alternatively or additionally, the short beginning portion is stored on a streaming server from which it may be downloaded by computers 102. It is noted that the beginning portion may be the same size as other blocks, rather than being shorter. On the other hand, the beginning portion may be very small, for example less than 1000 bytes, or even may not be used at all. In some embodiments of the invention, as mentioned hereinabove, the beginning portion is included in the descriptor of the file.

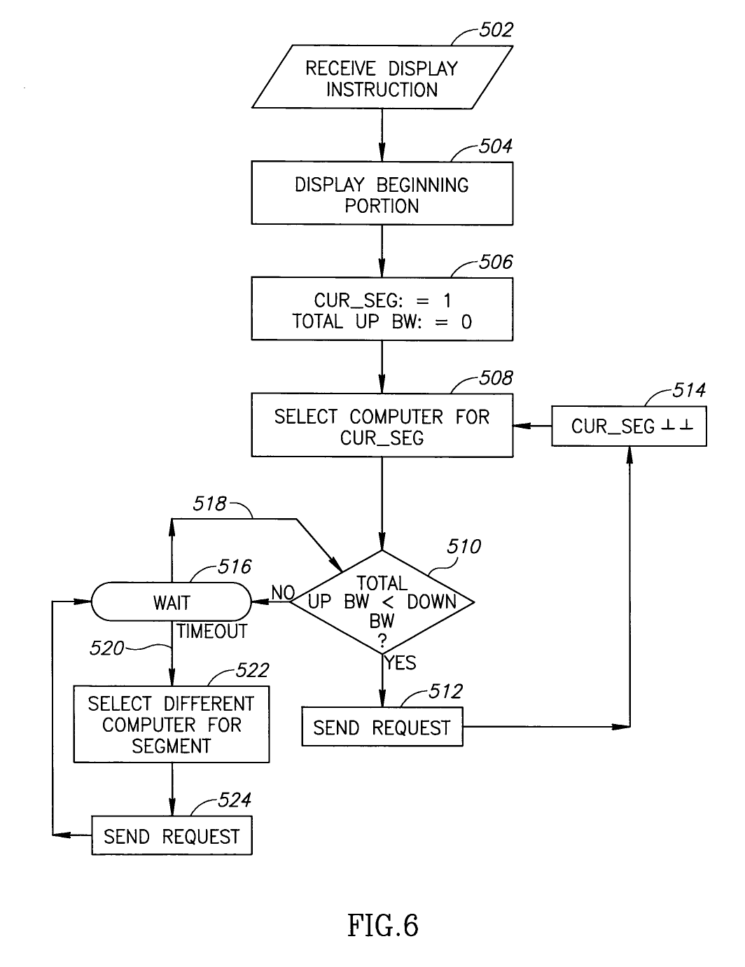

FIG. 6 is a flowchart of a method of file retrieval from a distributed storage system, in accordance with an exemplary embodiment of the invention. Upon receiving (502) an instruction to retrieve (e.g., display) a file, sharing process 108 passes (504) the beginning portion stored locally to a retrieval process. In addition, sharing process 108 sets (506) a first segment of the file to be a current segment and initializes a total uplink bandwidth variable.

Sharing process 108 selects (508) a computer to provide the current segment. If (510) the total uplink bandwidth of the previously selected computers, together with the uplink bandwidth of the currently selected computer is smaller than the downlink bandwidth of the retrieving computer, possibly with a safety margin, a request for the segment is sent (512) to the computer, the current segment counter is advanced (514) and a computer for the new current segment is selected (508). If (510), however, the total uplink bandwidth with the uplink bandwidth of the currently selected computer is greater than the downlink bandwidth, sharing process 108 moves to a wait state (516).

From the wait state, when the reception of one or more segments is completed (518), sharing process returns to check (510) if the total bandwidth is lower than the downlink bandwidth. If during the wait state (516), a time out for receiving a requested segment expires (520), sharing process 108 selects (522) a different computer to provide the segment and sends (524) the computer a request.

These acts are repeated until all the segments are received and optionally displayed.

### Computer Selection

Referring in detail to selecting (508) a computer to provide the segment, in some embodiments of the invention, the selection is performed based on knowledge on the parameters and/or current usage of the computers storing the block including the segment. Optionally, the segment is not requested from computers already using more than a predetermined percentage (e.g., 50%, 70% or 90%) of their uplink bandwidth on providing previous segments of the file. In some embodiments of the invention, the uplink bandwidth of each computer hosting the segment is compared to the sizes of the segments currently being supplied by the computer divided by the time remaining until the segments need to be received. The remaining time is optionally measured up to a timeout point at which sharing process 108 will request the segment from a different computer.

In some embodiments of the invention, sharing process 108 additionally determines, for each computer, whether it will be required to provide a subsequent segment in the near future. Preference is optionally given to requesting segments from computers that are not expected to be required for other segments in the near future.

Alternatively or additionally, the selection (508) of a computer to provide the segment is performed responsive to the upload bandwidth of the computers. For example, when a relatively short time remains until a segment is required for display, the segment is requested from a high bandwidth computer, whereas when more time remains the segment is requested from a low uplink bandwidth computer. In some embodiments of the invention, preference is given to selecting computers that are closest to the displaying computer, for example as measured by the round trip time (RTT).

Optionally, the segments are requested in accordance with a relatively even distribution method, such as a round robin method, unless deviation from this distribution is required in order to achieve delivery on time. In an exemplary embodiment of the invention, each segment is requested from the computer from which a segment was requested longest ago or from a computer not yet used, unless that computer cannot provide the segment at a sufficient rate. In some embodiments of the invention, each computer is assigned an upload score and the selection prefers computers that have a low upload score indicating that so far they provided fewer segments.

In some embodiments of the invention, the retrieval order of segments is determined in parallel to the download of the file. Alternatively, the entire download order of files is determined in advance, before beginning to download the file or at the beginning of the download. Optionally, the requests for segments are transmitted gradually, each time the retrieval time of a segment is reached. Alternatively, the entire plan for transmission of segments is provided to each peer in advance or with the first request from that peer, and the peer times the upload of the segments according to the instructions received in advance. Intermediate approaches may also be possible. In some embodiments of the invention, the peers receiving the requests determine whether they will be able to meet the delivery at the desired times and notify the displaying computer as to which blocks they will not be able to provide, for example because they received requests from other computers. The displaying computer then requests a different peer computer to provide the block.

In some embodiments of the invention, the plan for transmission of segments includes for some or all of the segments one or more standby computers which are to provide the segment in case the intended computer fails to do so. Optionally, the standby computers are listed in an order in which they will be requested to provide the segment in case all other computers higher in the list notify that they cannot provide the segment or fail to provide the segment. In some embodiments of the invention, in transmitting the request plan to the peer computers, the plan also indicates for which blocks the requested computer is in standby to provide the segment and where in the standby list the computer is located. Optionally, the computers may notify when they will not be able to deliver the file or may encounter problems delivering it, also regarding blocks for which they are in standby. The requesting computer optionally may change the instructions provided to the peer computers during the progression of the display, according to the developments.

Optionally, sharing process 108 attempts to retrieve consecutive segments of a same block, from the same computer. Optionally, if the uplink bandwidth of the computer providing a first segment of the block is greater than required for delivery (e.g., real time delivery) of the file by a safety margin (e.g., 120% of the required bandwidth), the entire block is provided by the same computer. If, however, the uplink bandwidth is smaller, one or more additional computers are requested to deliver segments of the block.

### Delivery

As to determining (510) whether the total uplink bandwidth is not too large, in some embodiments of the invention, a safety margin is defined to allow for cases in which a retransmission is requested from the same or from a different computer due to a time out, and therefore both computers may end up sending the same data.

It is noted that the segments are not necessarily requested one at a time. If, for example, it is determined that a computer has the required bandwidth to deliver a plurality of segments together, it is possible that sharing process 108 will request a plurality of consecutive or non-consecutive segments in a single request.

By limiting requests to a total uplink bandwidth lower than the downlink bandwidth of the displaying computer, the possibility that data requested at a later time will be delivered at the expense of data required urgently is substantially eliminated.

Alternatively or additionally, in requesting delivery of a segment, sharing process 108 of the displaying computer indicates a maximal rate at which the segment is to be delivered.

Rather than requesting segments to the maximal amount allowed by the download bandwidth of the displaying computer, any other suitable rate may be used to govern the requesting process. For example, instead of the download rate of the displaying computer less a safety margin, the bandwidth required to display the movie, with an additional grace factor that compensates for fluctuations may be used.

In some embodiments of the invention, the timeout at which a further request for the same segment is transmitted is selected at a point allowing sufficient time for the segment to be transmitted twice, in case the transmission is slow or the second computer requested to deliver the segment is busy.

Optionally, at the time of selecting a computer to deliver the segment, one or more computers are already selected as backups in case the delivery from the main computer fails. In an exemplary embodiment of the invention, three backup computers are selected.

In order to ensure timely delivery, in some embodiments of the invention, sharing process 108 may send requests for the same segment to a plurality of computers concurrently, for example when time is short and sufficient downlink bandwidth is available to allow for the redundant transmission.

In some embodiments of the invention, one or more of the blocks have been previously stored locally and these blocks are retrieved from shared region 106. It is noted, however, that in some cases the blocks that are to be stored locally according to the sharing process have not yet been stored locally, as the display is performed in parallel with the sharing process. In these cases, the blocks determined to be stored locally are optionally downloaded in their turn from other peers storing the blocks as all the other blocks. The downloaded blocks that are to be stored locally are stored before or after their display, unlike the other blocks which are optionally discarded after their display.

### Block Rescue

In some embodiments of the invention, computers 102 committing to store a block are required to store the block only as long as they are participating in the sharing scheme. In some embodiments, each computer may unilaterally leave the sharing scheme. Optionally, a computer leaving the sharing scheme notifies the peers to which it has committed to store blocks, so that they can find replacements. Alternatively, the peer computers determine that their peer has left the sharing scheme based on non-answered queries. Upon determining that the computer has left the sharing scheme, the peer computers update their sharing scheme to overcome the changes due to the leaving computer, if necessary. In some embodiments of the invention, however, a user is not allowed to leave the scheme unilaterally, without permission from the peers that acknowledge that there remain a sufficient number of peers still storing the file.

In some embodiments of the invention, if a required block is not stored by any of the computers that committed to store the block for computer 102, for example when computer 102 was disconnected from the network for a long time, the computer 102 requests that the committing computers fetch the block from their peers on its behalf.

### Further Embodiments

As mentioned above, the above methods may be used in a plurality of different environments. In one exemplary embodiment of the invention, a channel recorder continuously records multiple broadcasting channels and stores program units in separate files. A meta-data file is generated for each file and is distributed throughout a network, such as a network of set-top boxes. Each set-top box begins a sharing process for the file and determines which blocks of the file it is to store. These blocks are then downloaded by the set-top box from the channel recorder or are delivered using any other method. Using set-top boxes with current size memory units (e.g., 300 Gbytes), a group of 10,000 set-top boxes can store together at real time availability the contents of 75 channels for an entire year, assuming a file size per year of about Gbytes. In this calculation, a redundancy factor of 10 is assumed, that is each block is stored 10 times on the average.

The provided files may be distributed in accordance with substantially any appropriate business model known in the art. The files may be accompanied by ads, the users may be required to pay for a subscription or on a per view basis or may buy a copy of the file or rent a copy of the file for a limited amount of time. Substantially any enforcement method known in the art may be used to ensure that the users comply with the selected business model, such as any of the methods described in US patent publications 2008/0010653 to Ollikainen et al., 2007/0266399 to Sidi, 2006/0222322 to Levitan or 2007/0038578 to Liu et al., the disclosures of all of which are incorporated herein by reference in their entirety.

The description hereinabove relates to a video file in which the order of the segments is their order of play. It is noted that the principals of these embodiments may be applied for use with other types of files, having other segment orders of importance. For example, in receiving software installation packages, such as commonly used in Linux distributions, and/or compressed Zip files, the order of delivery may optionally be selected to allow fast decompression and/or installation.

In some embodiments of the invention described herein, sharing process 108 determines which blocks of a file are stored by other peer computers and accordingly determines a specific group of blocks to be stored locally. In other embodiments of the invention, sharing process 108 may ensure delivery of the specific group of blocks from a different source. For example, rather than storing its share of blocks locally, a computer may pay or otherwise receive the consent of a server or a different peer to store the blocks on its behalf. Optionally, in such cases, peers requesting a block from the computer are redirected to the entity storing the block for the computer. Alternatively, the tables of the peer computers state the address of the entity storing the blocks, although the credit is given to the computer.

In still other embodiments of the invention, a computer 102 may be allowed a limited usage of the peer-to-peer network, without being required to store blocks for other computers. The computer 102 optionally performs the sharing process to determine which blocks it can download from peers in real time and which need to be downloaded in advance and/or from a server.

### CONCLUSION

It is noted that the sharing process may be performed in parallel to the download process, the computer performing the download storing the blocks of the file that it determined to store when they are received and discarding the other blocks once they were displayed. A new corner to the network desiring to receive a block of the file from the computer performing the parallel sharing and display will require the blocks only after the computer has them, as video files are viewed sequentially. Therefore, the computer performing the download and sharing concurrently will have the portions needed by the new corner when they are required.

Although it is advantageous to use both the storage and retrieval methods described hereinabove, it is possible to use sharing methods in accordance with embodiments of the present invention with other retrieval methods and it is possible to use a retrieval method in accordance with embodiments of the present invention within networks using other distributed storage methods.

It will be appreciated that the above described methods may be varied in many ways, including, changing the order of steps, and/or performing a plurality of steps concurrently. It will also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific implementation details may be used.

It should be understood that features and/or steps described with respect to one embodiment may sometimes be used with other embodiments and that not all embodiments of the invention have all of the features and/or steps shown in a particular figure or described with respect to one of the specific embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Variations of embodiments described will occur to persons of the art. Therefore, the scope of the invention is limited only by the elements and limitations as used in the claims, wherein the terms “comprise,” “include,” “have” and their conjugates, mean “including but not necessarily limited to.”

1. A method of storage management of a file, comprising:
determining, by a first computer, for a plurality of peer computers, whose storage content of the file is not controlled by the first computer, in a communication network of the first computer, information on the storage management of blocks of the file by the peer computers;
selecting, by the first computer, blocks of the file to be made available to the first computer independently of the plurality of peer computers, responsive to the determined information; and
managing a storage unit of the first computer, such that the non-selected blocks of the file are not stored locally by the first computer.

2. A method according to claim 1, comprising the first computer creating a table indicating for each block not stored in the storage unit of the first computer, from which peer computers it may be retrieved.

3. A method according to claim 1, wherein determining for a plurality of peer computers comprises determining for up to a maximal number of peer computers.

4-8. (canceled)

9. A method according to claim 1, wherein the plurality of peer computers are selected at least partially responsive to times at which they joined the sharing of the file.

10. A method according to claim 1, wherein the plurality of peer computers are selected at least partially responsive to scores given to the peer computers relating to an extent of their participation in storing blocks of shared files.

11-12. (canceled)

13. A method according to claim 1, wherein selecting blocks of the file to be made available to the first computer independently of the plurality of peer computers comprises selecting responsive to a determination as to which blocks are stored by a low number of the plurality of peer computers.

14. A method according to claim 1, wherein selecting blocks of the file comprises determining for each block which peer computers have committed to other peer computers to store the block.

15. (canceled)

16. A method according to claim 1, wherein managing the storage unit of the first computer comprises erasing non-selected blocks from the storage unit.

17. A method according to claim 1, comprising requesting, for each block not selected, commitments to store the block, from one or more peer computers.

18. (canceled)

19. A method according to claim 17, comprising verifying periodically that the computers providing commitments are available and their commitment is in force.

20-21. (canceled)

22. A method according to claim 1, comprising determining a score for the first computer, based on the number of selected blocks.

23-27. (canceled)

28. A method according to claim 1, wherein managing the storage unit of the first computer comprises storing the selected blocks on the storage unit of the first computer.

29. A method according to claim 28, wherein the file comprises a video file and wherein the first computer begins to display the file before all the selected blocks are stored on the storage unit of the first computer.

30. A method of storage management of a video file, comprising:
determining for a plurality of peer computers in a communication network of a first computer, information on the storage management of blocks of the file by the peer computers;
selecting blocks of the file to be stored locally on a storage unit of the first computer, responsive to the determining for the plurality of peer computers;
storing the selected blocks on the storage unit of the first computer; and
displaying the video file by streaming the blocks not selected to be stored locally from the plurality of peer computers in real time,
wherein the displaying of the video file begins before all the selected blocks are stored on the storage unit of the first computer.

31. A method according to claim 30, wherein the blocks of the file are downloaded for display, and the selected blocks are stored locally when they are downloaded for the display.

32. A method according to claim 31, wherein the blocks of the file are downloaded for display substantially in the order of the display, and the selected blocks are stored locally when they are downloaded for the display.

33. A method according to claim 31, wherein the determining of the information on the storage management of blocks of the file by the peer computers and the selecting of the blocks to be stored on the first computer, are performed by the first computer.

34-46. (canceled)

47. A computer configured for peer communications, comprising:
a network interface configured for communication with other computers;
a storage unit; and
a processor configured to determine for a plurality of peer computers, information on the storage management of blocks of a file by the peer computers, to select blocks of the file to be stored on the storage unit responsive to the determined information and to store the selected blocks in the storage unit.

48. A computer according to claim 47, wherein the processor is configured to transmit through the network interface requests from peer computers to store the blocks of the file not selected for local storage.

49. A computer according to claim 47, wherein the processor is configured to transmit through the network interface requests from peer computers to commit to store the blocks of the file not selected for local storage.

50-53. (canceled)
